(19) United States
(12) Patent Application Publication
(10) Pub. No.: US 2009/0087311 A1
(43) Pub. Date: Apr. 2, 2009

(54) Vertically Adjustable Horizontal Axis Type Wind Turbine And Method Of Construction Thereof

(76) Inventor: Gavin Raymond Wyborn, Pokfulam (HK)

Correspondence Address: Gavin Raymond Wyborn, 6A New Alberose, 132-136 Pokfulam Road, Pokfulam, HK

(21) Appl. No.: 11/864,953

(22) Filed: Sep. 29, 2007

(51) Int. Cl. F03D 11/04; E04H 12/34; F03D 1/00; B23P 11/00; E04H 12/00

(52) U.S. Cl. 416/9; 52/29; 416/147; 29/889

(57) ABSTRACT

The invention relates to methods of constructing and operating a wind turbine, said methods comprising the steps of lifting a wind turbine nacelle and tower sections with the use of an external lifting system, and using a lifting system to propel said nacelle vertically up and down said tower sections. The external lifting mechanism comprises a guide rail and guide car onto which tower sections are loaded for horizontal movement, a foundation structure joined to a tower section hoist mechanism containing clamps, and a nacelle holding mechanism. A nacelle includes a tower penetrating hole through which said tower vertically penetrates. Tower sections are provided with a plethora of guide rails positioned around said tower extending from the lower end to the upper end of said tower sections, said guide rails contain removable toothed racks meshing with said lifting system to propel said nacelle vertically up and down said tower sections.

### BACKGROUND OF THE INVENTION

This invention relates to a wind turbine. A wind turbine is a device for converting the energy of wind into mechanical rotary energy through the medium of a propeller type windwheel possessed of a plurality of rotor blades and further converting this mechanical rotary energy into electric energy by, for example, an electric generator. The operating condition of the wind turbine varies with the velocity of the wind. Specifically, the revolution number and torque of the windwheel increase and the loads such as the force of air and the centrifugal force which are exerted on the rotor blades are also increased in proportion as the velocity of wind increases. To fix the revolution number of the rotor blades, the motion of the blades is controlled by means of a variable pitch mechanism, for example. This control mechanism, however, fails to provide the expected control when the blades are exposed to a wind of unusually high velocity such as those encountered during a typhoon. Under the great pressure of the wind, the rotor blades and the rotation system of the motor may, in an extreme case, even break. The wind turbine, therefore, has an evident need of being provided with a safety measure to preclude breakage whilst still generating electrical energy.

The rotor blades in the majority of the existing windwheels are made of glass fiber, aluminium and wood. They must be given maintenance and inspection at fixed intervals of once at least every several months. At times, they must be replaced. In some of the existing wind turbines, the propeller type windwheels are installed on towers which stand 40 to 90 meters from the ground level. The replacement of rotor blades and the maintenance and inspection given to the interior of the nacelle, accordingly, have entailed extremely dangerous work at great heights.

As one kind of the safety measure of the type mentioned above, we propose a method by which the turbine nacelle and windwheel is lowered automatically to reduce stresses on the tower and on the windwheel blades whenever high winds are encountered. Wind speeds increase the higher above ground you are, conversantly, they reduce the closer you are to the ground. By reducing the height of the nacelle and blades, lower winds will likely be experienced.

A major concern of wind turbine owners is the number of kilowatt hours of electrical energy produced by a wind turbine. Historically, in high winds, turbines require shut-down, however, peak wind conditions are also peak power generating conditions. We propose that instead of shutting down a wind turbine during its peak operating environment, the wind turbine operating conditions should be altered to take advantage of these environmental factors, whilst reducing possible damage to the wind turbine system. In the event of catastrophic winds, the nacelle and blades would be lowered to the ground and operation stopped.

Using a system whereby the nacelle and blades are able to be lowered to ground level means maintenance work can be conducted rapidly and efficiently, whilst removing the need for working at dangerous heights. This methodology also removes the requirement for large cranes to be brought on-site to manage routine maintenance.

### BRIEF DESCRIPTION OF THE DRAWINGS

FIG. 1 is a side view of a horizontal access wind turbine and construction mechanism thereof according to an embodiment of the present invention;

FIGS. 2a through 2ze are explanatory views showing an outline of a construction method of a horizontal axis type wind turbine according to an embodiment of the present invention;

FIG. 3 is a sectional top elevation view and side elevation view of a tower section according to an embodiment of the present invention;

FIG. 4 is a sectional top elevation view of the lifting apparatus in situ whilst penetrating a tower section according to an embodiment of the present invention;

FIG. 5 is an explanatory view showing an outline of a lifting apparatus according to an embodiment of the present invention;

FIG. 6 is a vertical cross section view of a nacelle, a lifting apparatus and a tower section according to an embodiment of the present invention;

FIG. 7 is a horizontal cross section view of a nacelle, a lifting apparatus and a tower section according to an embodiment of the present invention;

FIG. 8 is an explanatory view showing another form of a lifting apparatus according to an embodiment of the present invention.

### DETAILED DESCRIPTION OF THE INVENTION

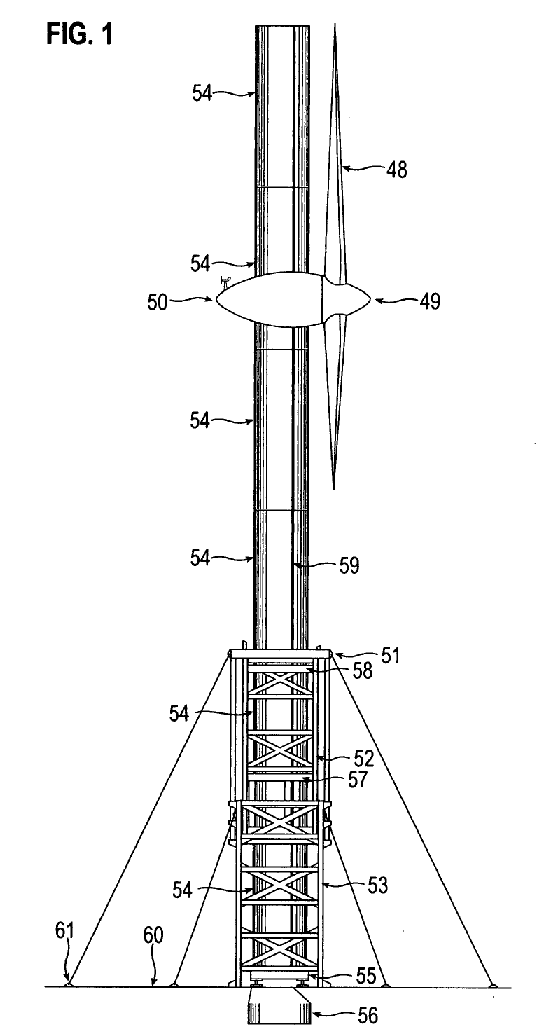

Referring now to FIG. 1, reference numeral 1 denotes a vertically adjustable horizontal axis type wind turbine and external lifting apparatus which comprises a base 60, a foundation 56 embedded within the base 60, a tower 54 made from tower sections 54 standing on the base 60, a nacelle 50 mounted on and vertically penetrated by the tower 54, a hub 49 supported by the nacelle 50, a rotor 48 including a plurality of blades 48 supported by the hub 49, a foundation structure 53, a tower section hoist mechanism 52 mounted on the foundation structure 53, a nacelle holding mechanism 51 mounted on the foundation structure 53, a tower section clamping mechanism 57 mounted on the tower section hoist mechanism 52, a tower section guide mechanism 58 mounted on the tower section hoist mechanism 52, stabilizing supports 61 mounted on the foundation structure 53 and nacelle holding mechanism 51 and base 60, a guide rail and guide car 55.

The tower includes a foundation 56 secured to a base 60, and a plurality of connecting tower members 54.

The foundation 56 is fabricated of metal and has a cylindrical or polygonal body, the foundation 56 is embedded within the base 60 and the foundation 56 is joined to the base 60 by bolts (not shown) or embedded directly within the base 60.

In another form of the invention, the foundation 56 and base 60 are removed and replaced by a prefabricated structure (not shown), the lowest tower section 54 is then joined to the prefabricated structure (not shown) using bolts (not shown) as if it were another tower section 54, the prefabricated structure (not shown) would then serve to replace the foundation 56 and the base 60.

The tower section 54 is fabricated of metal and has a cylindrical or polygonal body with a plethora of guide rails 59 mounted vertically along the length of the tower section 54, secured to the guide rails 59 by bolts (not shown) is as illustrated in FIG. 4 a plethora of removable toothed racks 67, tower sections 54 are vertically joined at each end using bolts (not shown) and the like.

The external lifting apparatus is fabricated of metal and has a square or rectangular shape, the nacelle holding mechanism 51 vertically penetrates the foundation structure 53 at a plethora of points, the nacelle holding mechanism 51 is raised vertically above the foundation structure 53 and secured in position using locking pins (not shown), the tower section hoist mechanism 52 is mounted on and surrounded by the foundation structure 53, the tower section hoist mechanism 52 is raised and lowered vertically through the foundation structure 53.

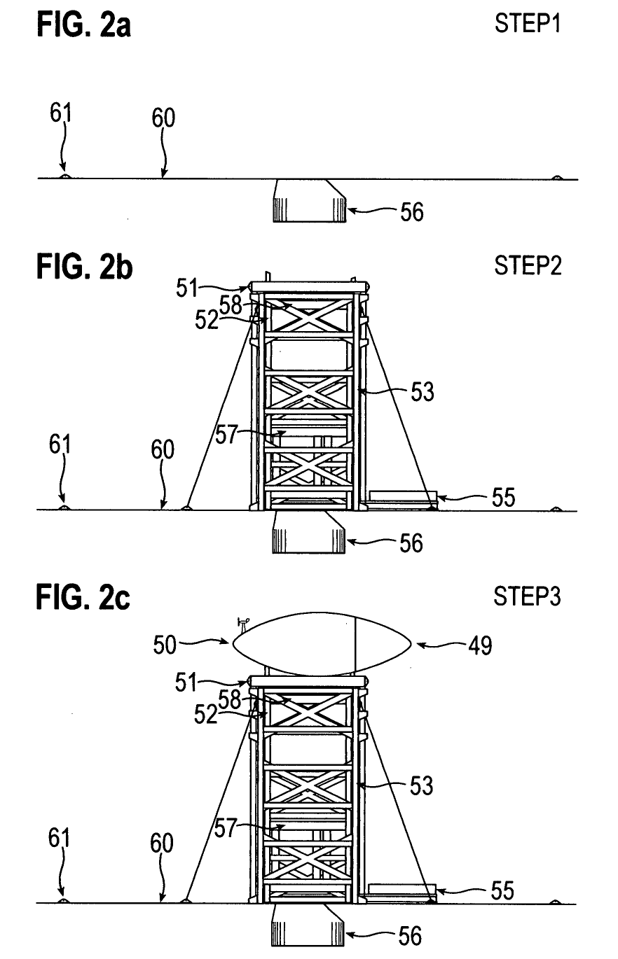

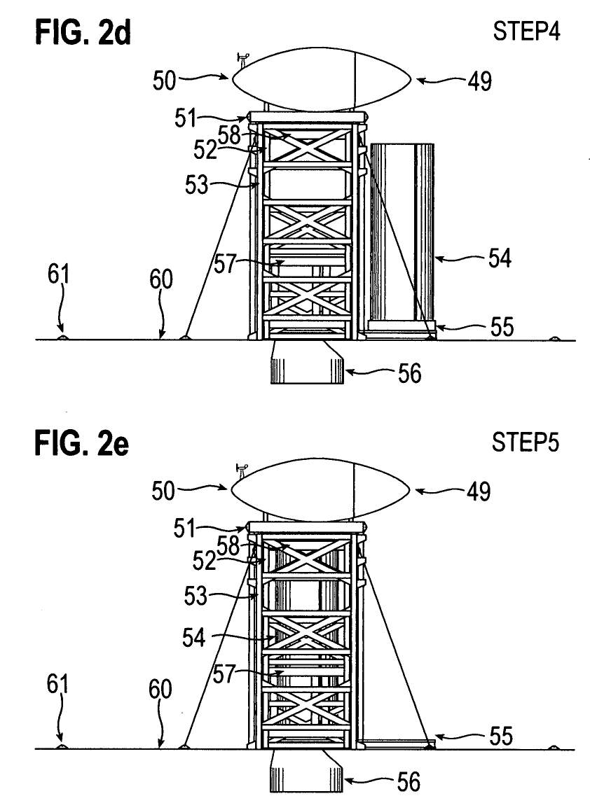

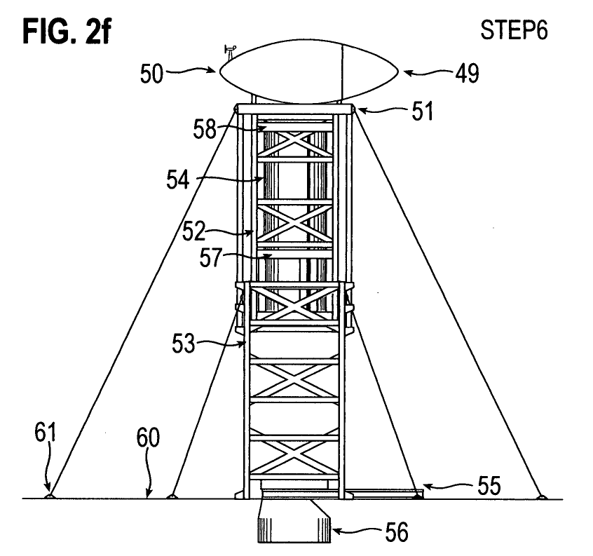

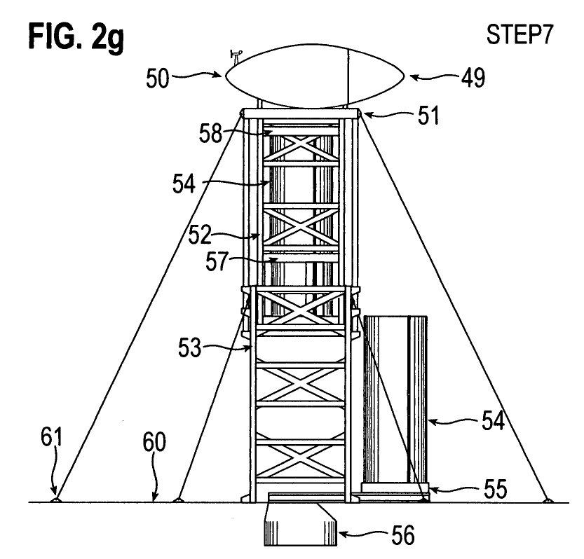

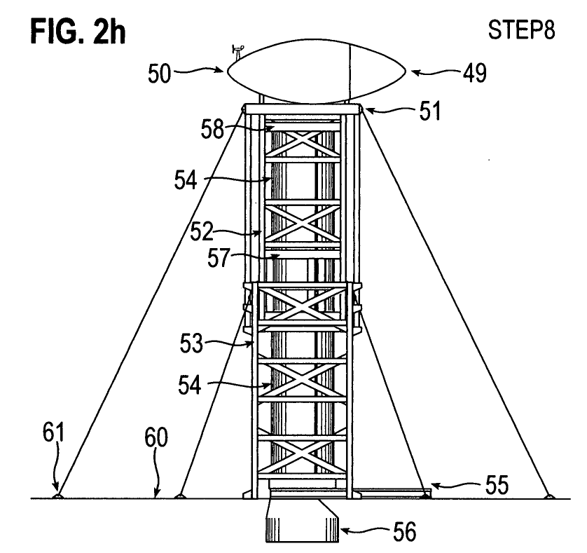

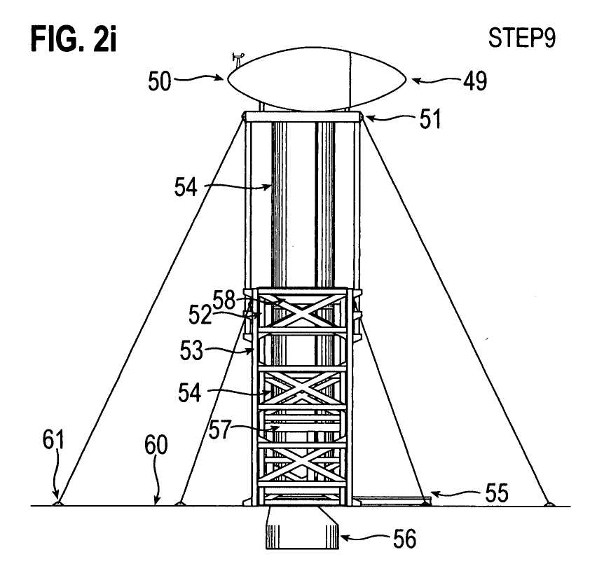

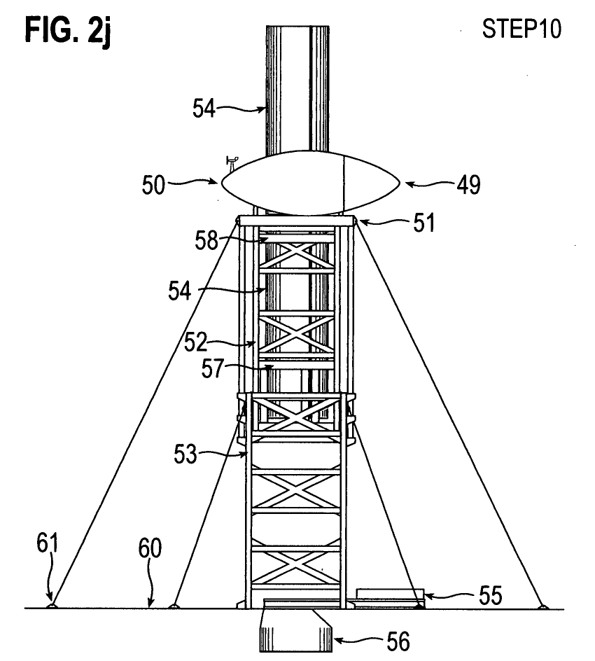

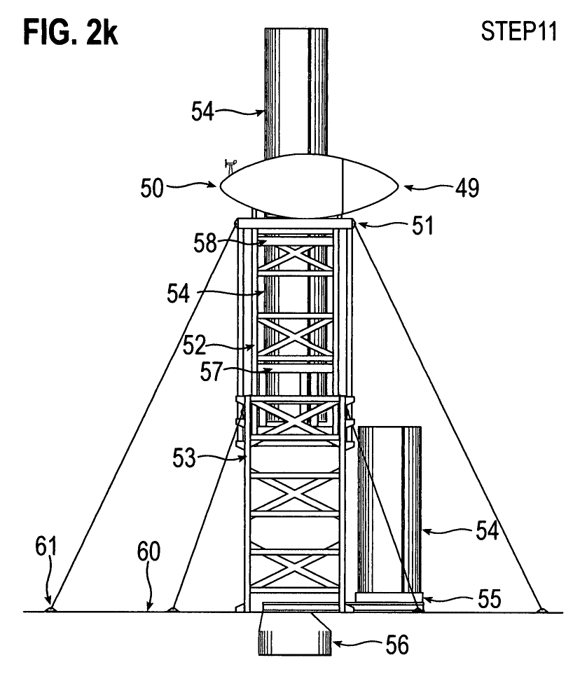

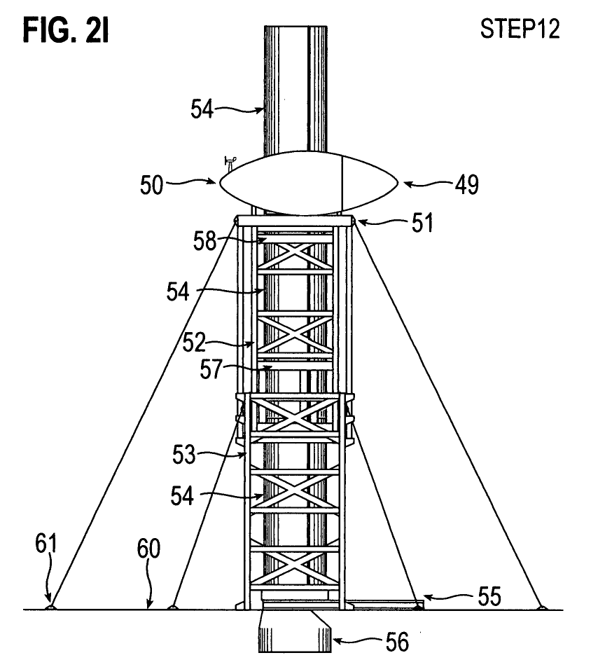

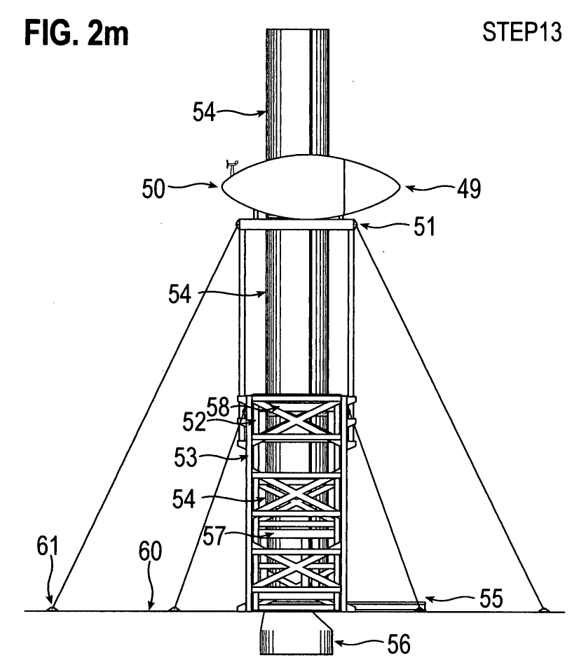

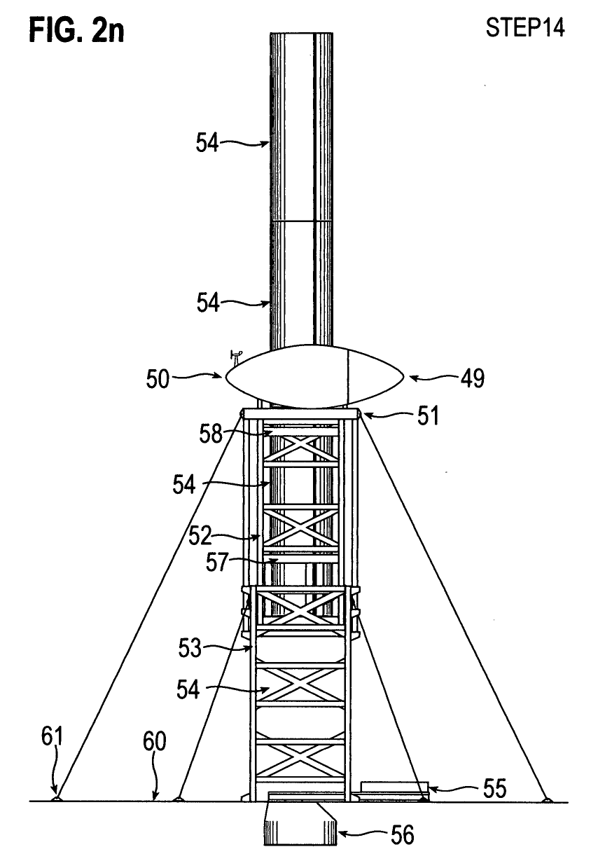

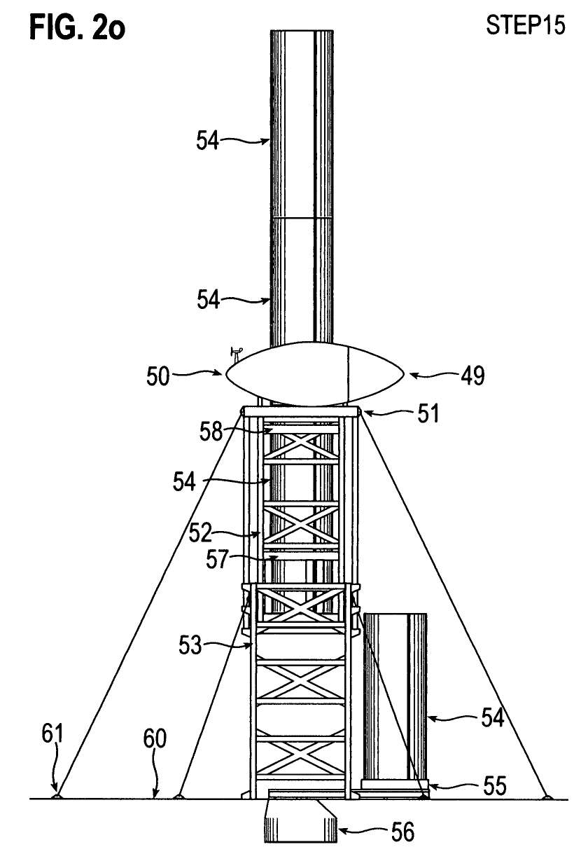

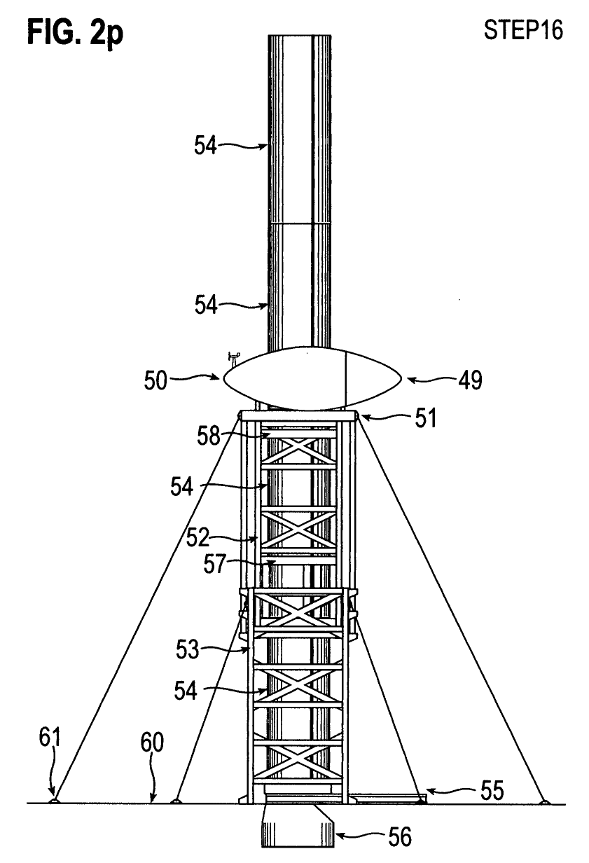

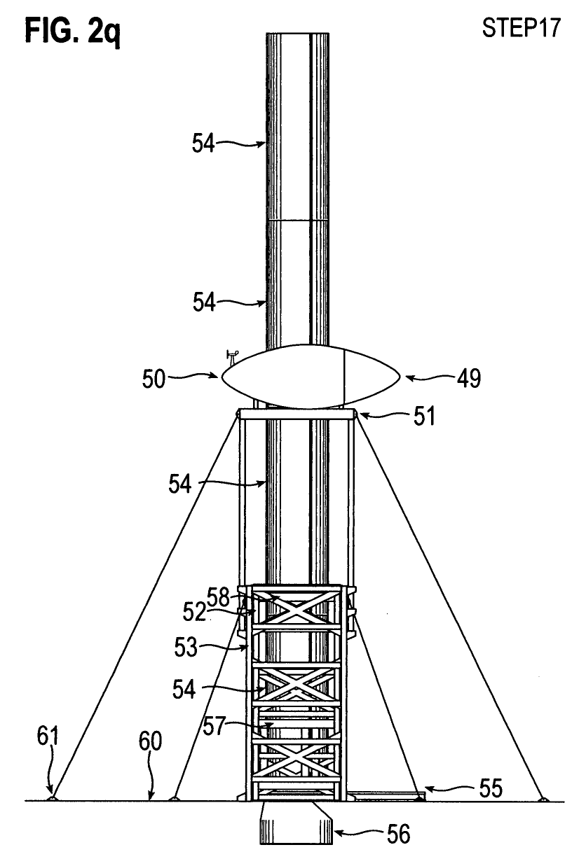

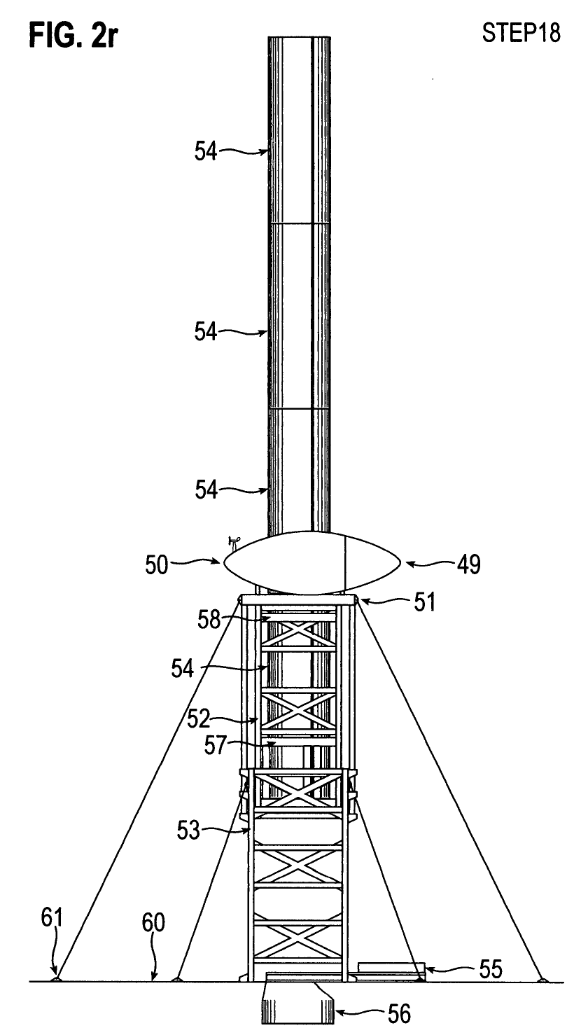

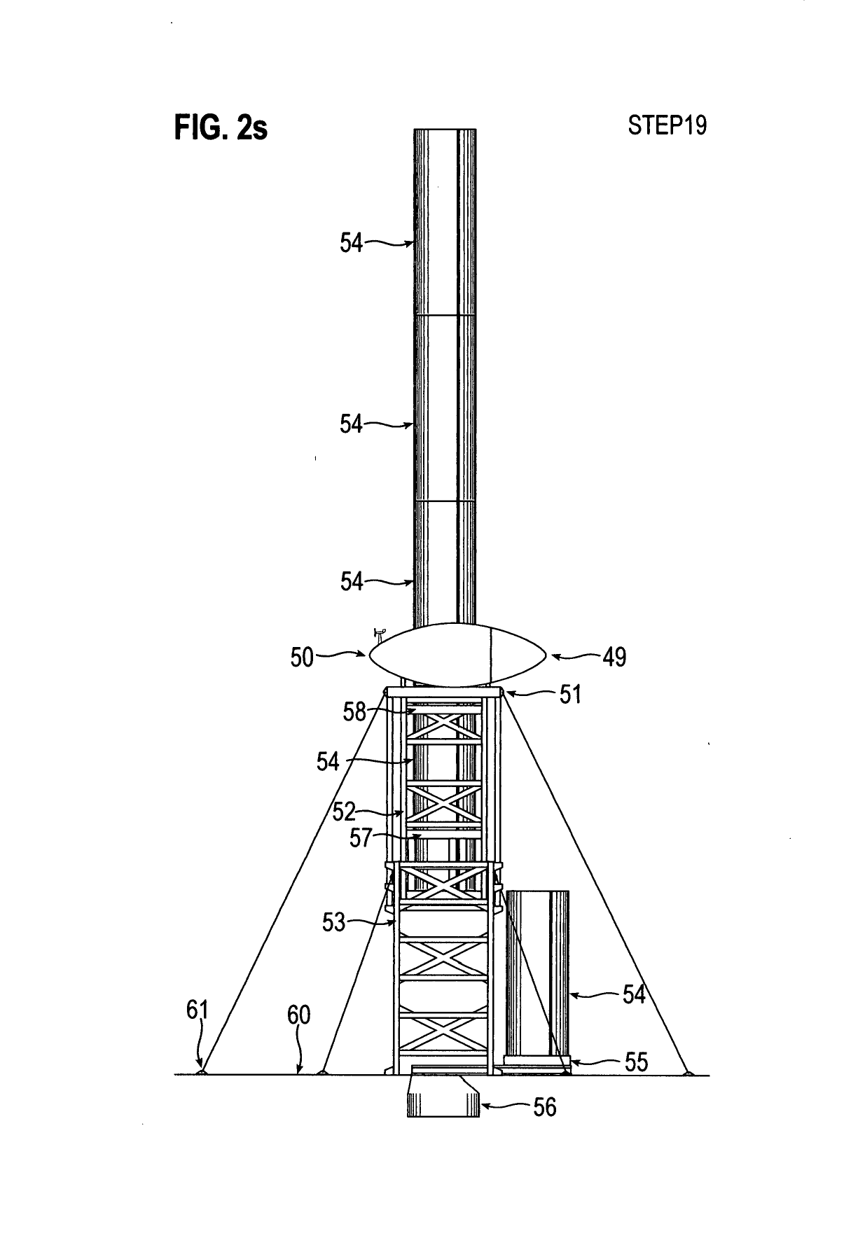

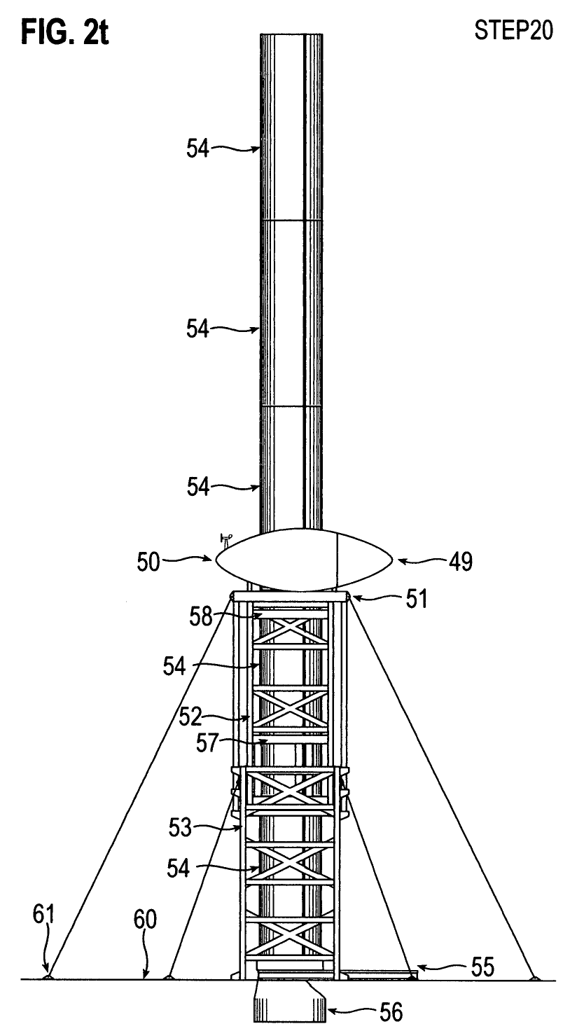

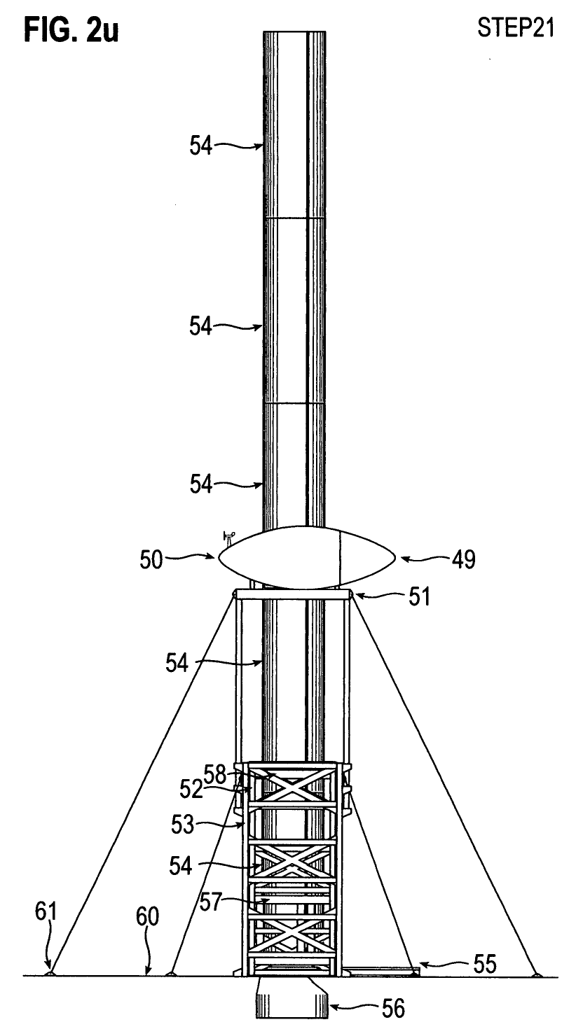

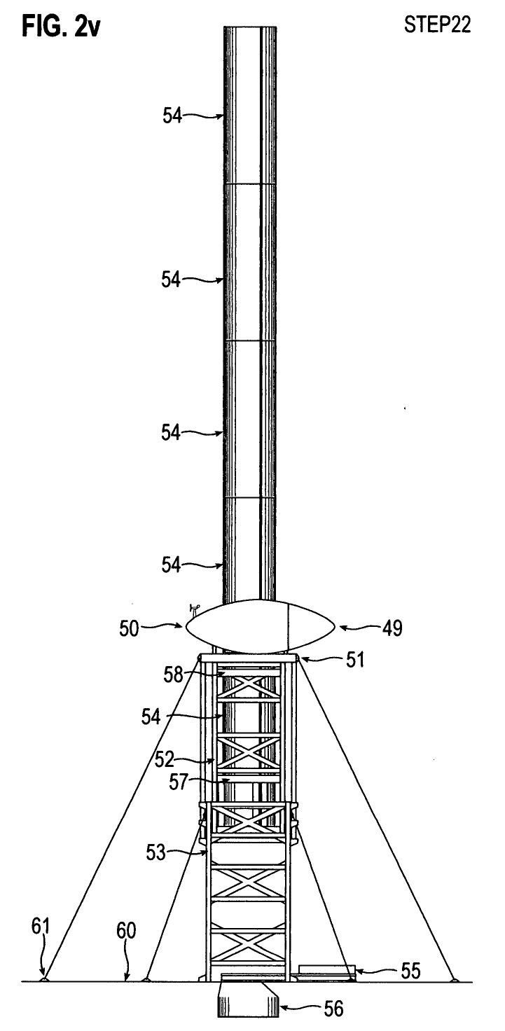

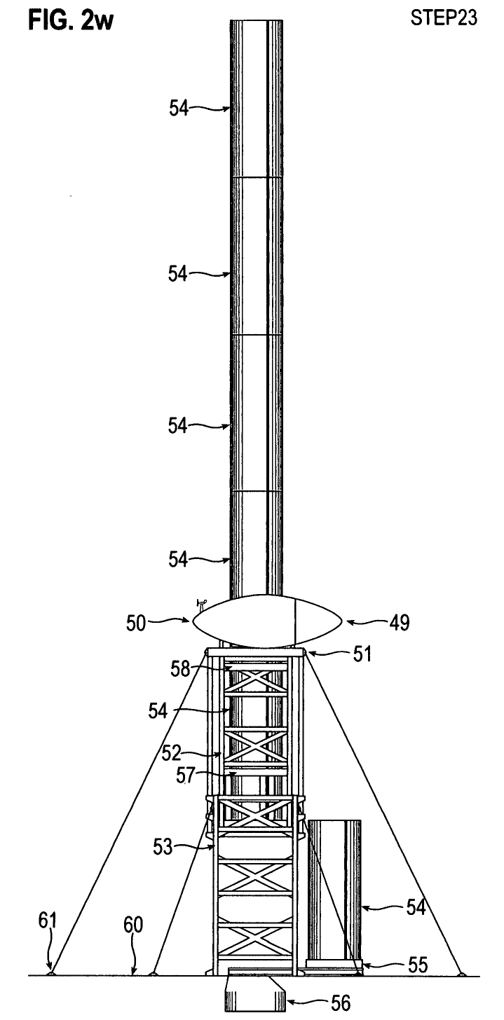

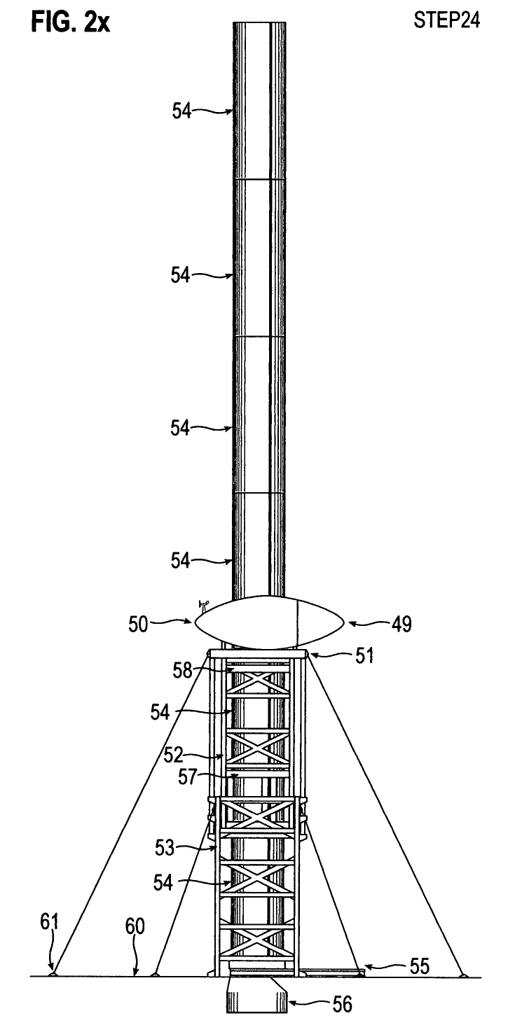

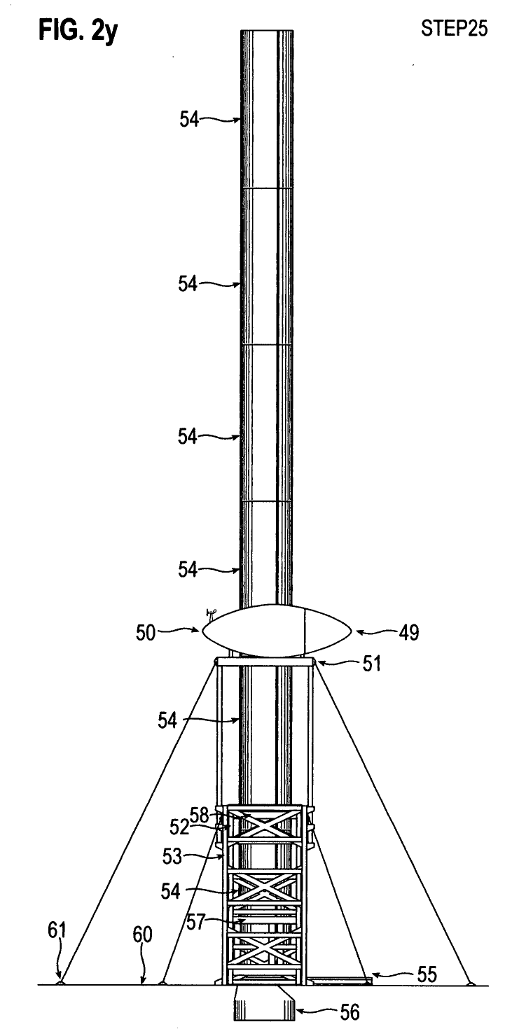

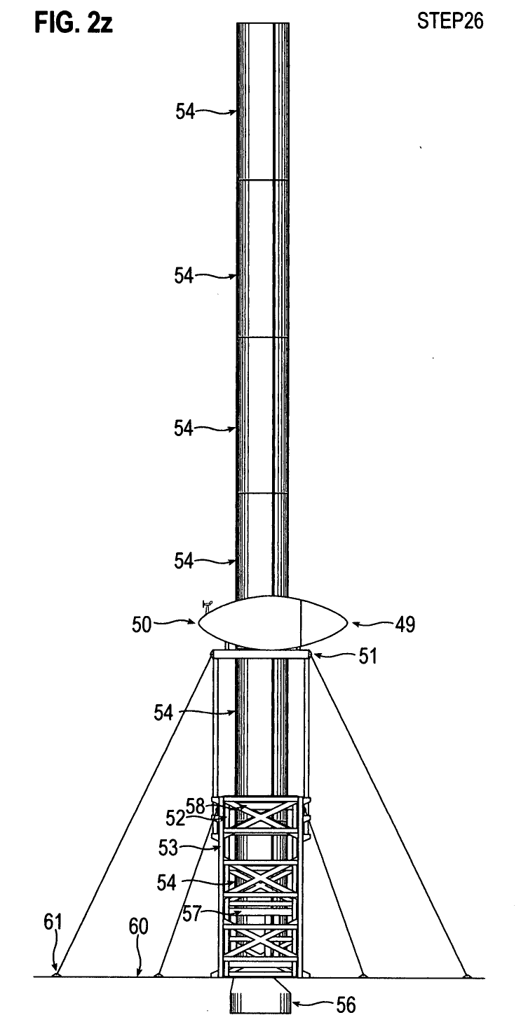

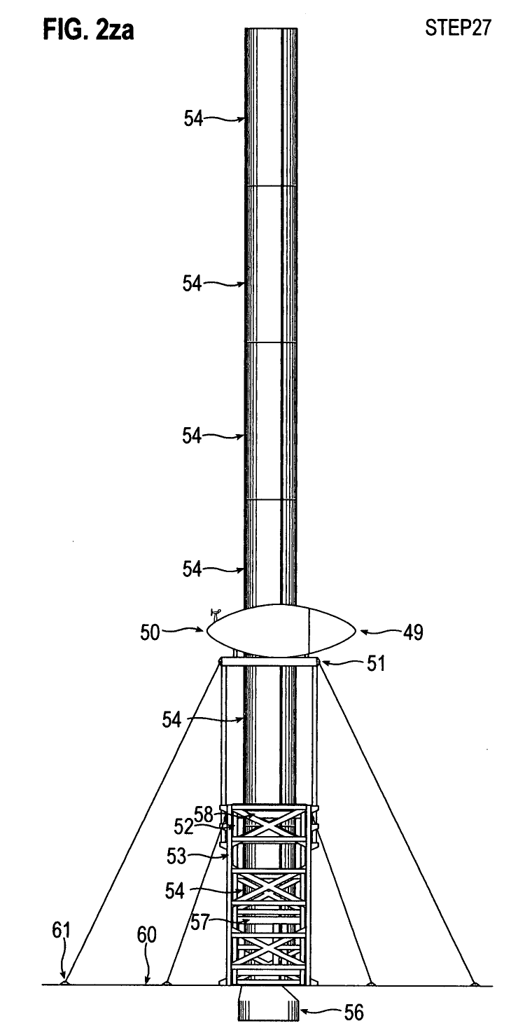

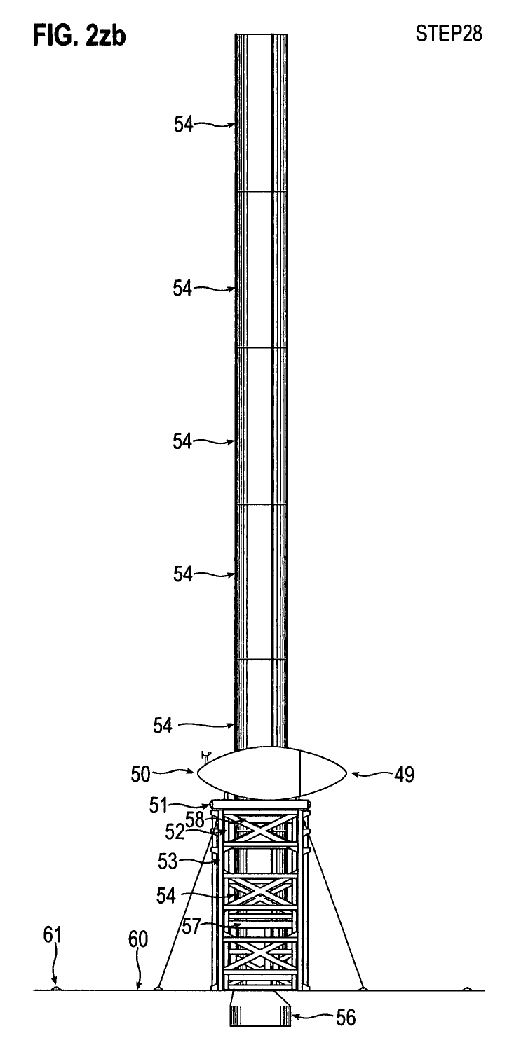

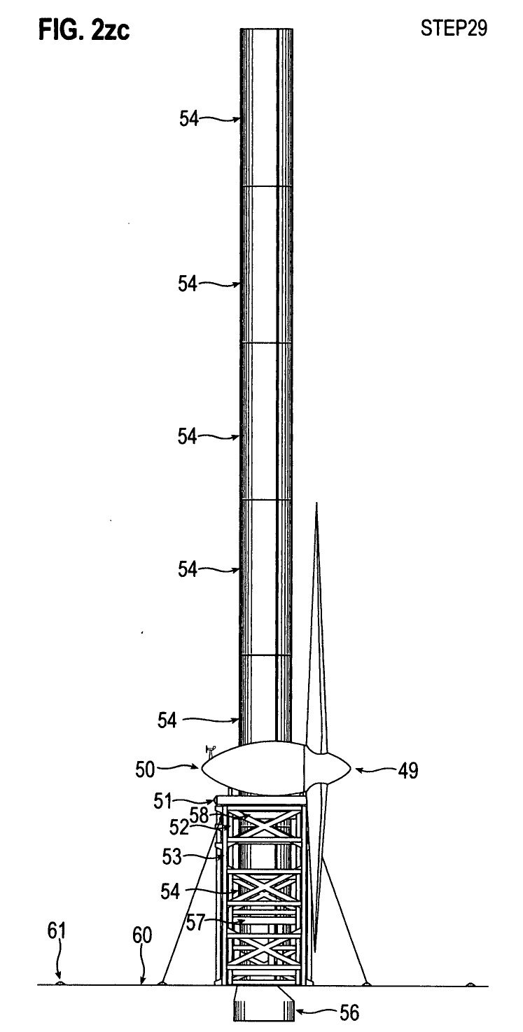

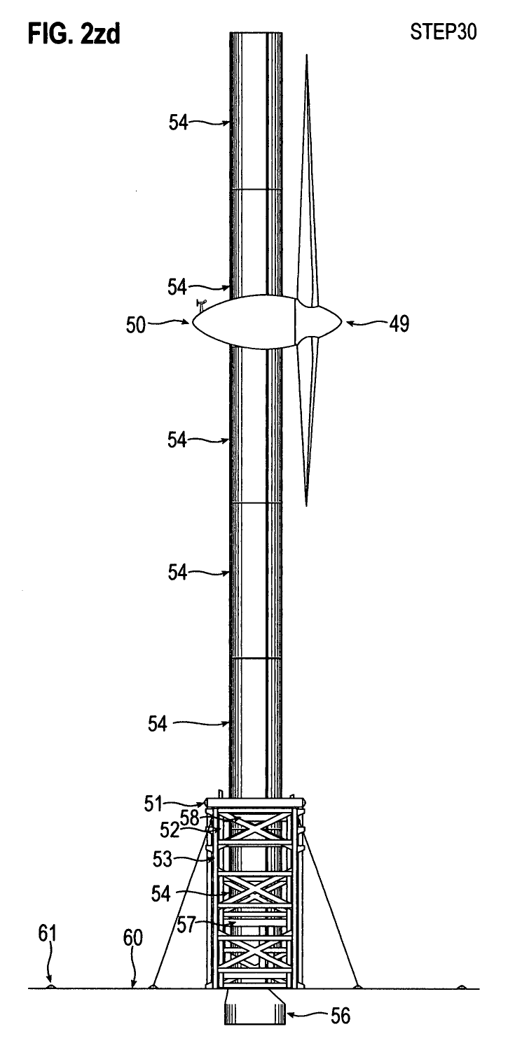

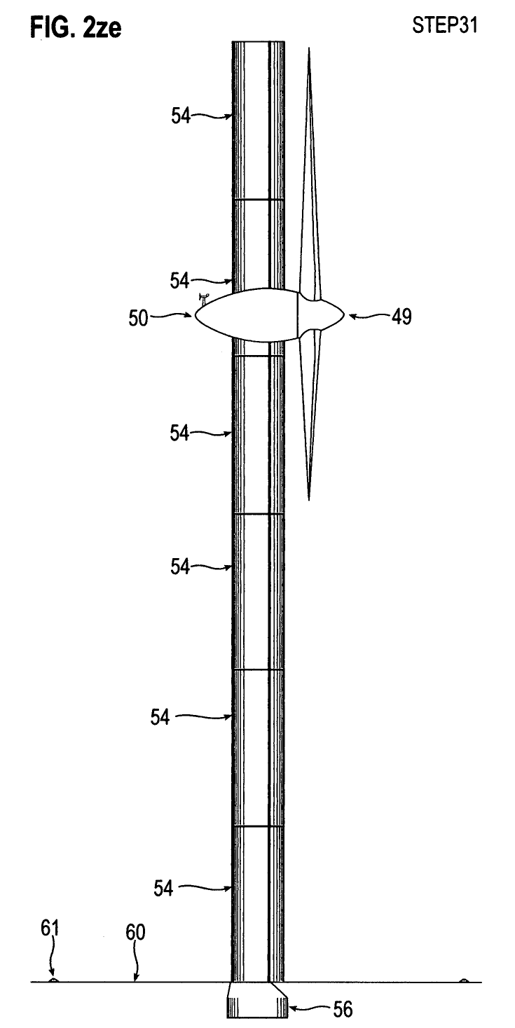

Next, the method of construction of thus constituted vertically adjustable horizontal axis type wind turbine 1 will be described by reference to FIGS. 2a through 2ze.

FIG. 2a, (STEP 1), the base 60 is constructed and embedded within or connected to the base 60 is the foundation 56, connected to the base 60 are the footplates of the stabilizing supports 61.

FIG. 2b, (STEP 2), the external lifting apparatus consisting of a foundation structure 53, a nacelle holding mechanism 51, a tower section hoist mechanism 52 upon which is mounted a tower section clamping mechanism 57 and a tower section guide mechanism 58, a guide rail and guide car 55, and stabilizing supports 61, is then temporarily mounted upon the base 60 using bolts (not shown) or locking pins (not shown).

FIG. 2c, (STEP 3), a nacelle 50 is placed on top of the nacelle holding mechanism 51 and a nacelle 50 is locked to the nacelle holding mechanism 51 using bolts (not shown) or locking pins (not shown).

FIG. 2d, (STEP 4), a guide car 55 is traveled horizontally along the guide car rail 55 to its furthest extension from a foundation structure 53, a tower section 54 is placed on top of a guide car 55 and a tower section 54 is temporarily secured to a guide car 55 using bolts (not shown) or locking pins (not shown).

FIG. 2e, (STEP 5), a guide car 55 with attached tower section 54 is traveled horizontally along the guide car rail 55 to its closest extension to a foundation structure 53, a guide car 55 is locked horizontally, a tower section clamping mechanism 57 is clamped onto a tower section 54, a tower section guide mechanism 58 is clamped onto a tower section 54, the bolts (not shown) or locking pins (not shown) used to temporarily secure a tower section 54 to a guide car 55 are removed.

FIG. 2f, (STEP 6), a tower section hoist mechanism 52 is raised vertically which also raises vertically a nacelle holding mechanism 51, a tower section clamping mechanism 57, a tower section guide mechanism 58, a tower section 54 clamped by a tower section clamping mechanism 57 and a tower section guide mechanism 58, a stabilizing support 61 joined to the nacelle holding mechanism 51, a nacelle 50, a hub 49 joined to a nacelle 50. A nacelle holding mechanism 51 is secured to a foundation structure 53 using locking pins (not shown).

FIG. 2g, (STEP 7), a guide car 55 is traveled horizontally along the guide car rail 55 to its furthest extension from a foundation structure 53. A tower section 54 is placed on top of a guide car 55 and a tower section 54 is temporarily secured to a guide car 55 using bolts (not shown) or locking pins (not shown).

FIG. 2h, (STEP 8), a guide car 55 with attached tower section 54 is traveled horizontally along a guide car rail 55 to its closest extension to a foundation structure 53 and aligned directly underneath a tower section 54 previously raised by a tower section hoist mechanism 52, a guide car 55 is locked horizontally, a tower section hoist mechanism 52 is lowered vertically to abut a tower section 54 clamped within the same against a tower section 54 secured to a guide car 55, a tower section 54 secured by the tower section hoist mechanism 52 and a tower section 54 secured to a guide car 55 are joined together where they abut using bolts (not shown), a tower section clamping mechanism 57 is un-clamped, a tower section guide mechanism 58 remains clamped.

FIG. 2i, (STEP 9), a tower section hoist mechanism 52 is lowered vertically which also lowers vertically a tower section clamping mechanism 57 and a tower section guide mechanism 58 which is clamped to a joined tower section 54, a tower section clamping mechanism 57 is clamped onto the lowest portion of a joined tower section 54.

FIG. 2j, (STEP 10), a tower section hoist mechanism 52 is raised vertically which also raises vertically a nacelle holding mechanism 51, a tower section clamping mechanism 57, a tower section guide mechanism 58, a joined tower section 54 clamped by a tower section clamping mechanism 57 and a tower section guide mechanism 58, raising the tower section hoist mechanism causes a joined tower section 54 to penetrate vertically a nacelle 50, a guide car 55 is traveled horizontally along the guide car rail 55 to its furthest extension from a foundation structure 53.

FIG. 2k, (STEP 11), a tower section 54 is placed on top of a guide car 55 and a tower section 54 is temporarily secured to a guide car 55 using bolts (not shown) or locking pins (not shown).

FIG. 2l, (STEP 12), a guide car 55 with attached tower section 54 is traveled horizontally along a guide car rail 55 to its closest extension to a foundation structure 53 and aligned directly underneath a joined tower section 54 previously raised by a tower section hoist mechanism 52, a guide car 55 is locked horizontally, a tower section hoist mechanism 52 is lowered vertically to abut a joined tower section 54 clamped within the same against a tower section 54 secured to a guide car 55, a joined tower section 54 secured by a tower section hoist mechanism 52 and a tower section 54 secured to a guide car 55 are joined together where they abut using bolts (not shown), a tower section clamping mechanism 57 is un-clamped, a tower section guide mechanism 58 remains clamped.

FIG. 2m, (STEP 13), a tower section hoist mechanism 52 is lowered vertically which also lowers vertically a tower section clamping mechanism 57 and a tower section guide mechanism 58 which is clamped to a joined tower section 54, a tower section clamping mechanism 57 is clamped onto the lowest portion of a joined tower section 54.

FIG. 2n, (STEP 14), a tower section hoist mechanism 52 is raised vertically which also raises vertically a nacelle holding mechanism 51, a tower section clamping mechanism 57, a tower section guide mechanism 58, a joined tower section 54 clamped by a tower section clamping mechanism 57 and a tower section guide mechanism 58, raising the tower section hoist mechanism causes a joined tower section 54 to further penetrate vertically a nacelle 50, a guide car 55 is traveled horizontally along the guide car rail 55 to its furthest extension from a foundation structure 53.

FIG. 2o, (STEP 15), a tower section 54 is placed on top of a guide car 55 and a tower section 54 is temporarily secured to a guide car 55 using bolts (not shown) or locking pins (not shown).

FIG. 2p, (STEP 16), a guide car 55 with attached tower section 54 is traveled horizontally along a guide car rail 55 to its closest extension to a foundation structure 53 and aligned directly underneath a joined tower section 54 previously raised by a tower section hoist mechanism 52, a guide car 55 is locked horizontally, a tower section hoist mechanism 52 is lowered vertically to abut a joined tower section 54 clamped within the same against a tower section 54 secured to a guide car 55, a joined tower section 54 secured by a tower section hoist mechanism 52 and a tower section 54 secured to a guide car 55 are joined together where they abut using bolts (not shown), a tower section clamping mechanism 57 is un-clamped, a tower section guide mechanism 58 remains clamped.

FIG. 2q, (STEP 17), a tower section hoist mechanism 52 is lowered vertically which also lowers vertically a tower section clamping mechanism 57 and a tower section guide mechanism 58 which is clamped to a joined tower section 54, a tower section clamping mechanism 57 is clamped onto the lowest portion of a joined tower section 54.

FIG. 2r, (STEP 18), a tower section hoist mechanism 52 is raised vertically which also raises vertically a nacelle holding mechanism 51, a tower section clamping mechanism 57, a tower section guide mechanism 58, a joined tower section 54 clamped by a tower section clamping mechanism 57 and a tower section guide mechanism 58, raising the tower section hoist mechanism causes a joined tower section 54 to further penetrate vertically a nacelle 50, a guide car 55 is traveled horizontally along the guide car rail 55 to its furthest extension from a foundation structure 53.

FIG. 2s, (STEP 19), a tower section 54 is placed on top of a guide car 55 and a tower section 54 is temporarily secured to a guide car 55 using bolts (not shown) or locking pins (not shown).

FIG. 2t, (STEP 20), a guide car 55 with attached tower section 54 is traveled horizontally along a guide car rail 55 to its closest extension to a foundation structure 53 and aligned directly underneath a joined tower section 54 previously raised by a tower section hoist mechanism 52, a guide car 55 is locked horizontally, a tower section hoist mechanism 52 is lowered vertically to abut a joined tower section 54 clamped within the same against a tower section 54 secured to a guide car 55, a joined tower section 54 secured by a tower section hoist mechanism 52 and a tower section 54 secured to a guide car 55 are joined together where they abut using bolts (not shown), a tower section clamping mechanism 57 is un-clamped, a tower section guide mechanism 58 remains clamped.

FIG. 2u, (STEP 21), a tower section hoist mechanism 52 is lowered vertically which also lowers vertically a tower section clamping mechanism 57 and a tower section guide mechanism 58 which is clamped to a joined tower section 54, a tower section clamping mechanism 57 is clamped onto the lowest portion of a joined tower section 54.

FIG. 2v, (STEP 22), a tower section hoist mechanism 52 is raised vertically which also raises vertically a nacelle holding mechanism 51, a tower section clamping mechanism 57, a tower section guide mechanism 58, a joined tower section 54 clamped by a tower section clamping mechanism 57 and a tower section guide mechanism 58, raising the tower section hoist mechanism causes a joined tower section 54 to further penetrate vertically a nacelle 50, a guide car 55 is traveled horizontally along the guide car rail 55 to its furthest extension from a foundation structure 53.

FIG. 2w, (STEP 23), a tower section 54 is placed on top of a guide car 55 and a tower section 54 is temporarily secured to a guide car 55 using bolts (not shown) or locking pins (not shown).

FIG. 2x, (STEP 24), a guide car 55 with attached tower section 54 is traveled horizontally along a guide car rail 55 to its closest extension to a foundation structure 53 and aligned directly underneath a joined tower section 54 previously raised by a tower section hoist mechanism 52, a guide car 55 is locked horizontally, a tower section hoist mechanism 52 is lowered vertically to abut a joined tower section 54 clamped within the same against a tower section 54 secured to a guide car 55, a joined tower section 54 secured by a tower section hoist mechanism 52 and a tower section 54 secured to a guide car 55 are joined together where they abut using bolts (not shown), a tower section clamping mechanism 57 is un-clamped, a tower section guide mechanism 58 remains clamped.

FIG. 2y, (STEP 25), a tower section hoist mechanism 52 is lowered vertically which also lowers vertically a tower section clamping mechanism 57 and a tower section guide mechanism 58 which is clamped to a joined tower section 54, a tower section clamping mechanism 57 is clamped onto the lowest portion of a joined tower section 54.

FIG. 2z, (STEP 26), a tower section hoist mechanism 52 is raised vertically which also raises vertically a nacelle holding mechanism 51, a tower section clamping mechanism 57, a tower section guide mechanism 58, a joined tower section 54 clamped by a tower section clamping mechanism 57 and a tower section guide mechanism 58, raising the tower section hoist mechanism causes a joined tower section 54 to further penetrate vertically a nacelle 50, a guide car 55 and a guide car rail 55 is then removed from the external lifting apparatus.

FIG. 2za, (STEP 27), a tower section hoist mechanism 52 is lowered vertically to abut a joined tower section 54 clamped within a tower section clamping mechanism 57 against a foundation 56, a joined tower section 54 secured by a tower section hoist mechanism 52 and a foundation 56 are joined together where they abut using bolts (not shown), a tower section clamping mechanism 57 is un-clamped, a tower section guide mechanism 58 remains clamped.

In another form of the invention, the foundation 56 and base 60 are removed and replaced by a prefabricated structure (not shown), the lowest tower section 54 is then joined to the prefabricated structure (not shown) using bolts (not shown) as if it were another tower section 54, the prefabricated structure (not shown) would then serve to replace the foundation 56 and the base 60.

FIG. 2zb, (STEP 28), a tower section hoist mechanism 52 is raised vertically to abut against a nacelle holding mechanism 51, temporary pins (not shown) securing a nacelle holding mechanism in place are removed, a tower section hoist mechanism 52 is lowered which also lowers a nacelle holding mechanism 51 and a nacelle 50.

FIG. 2zc, (STEP 29), a plethora of electrical and electronic mechanisms are joined (not shown) to a nacelle 50, a plurality of blades 48 are joined to a hub 49 using bolts (not shown).

FIG. 2zd, (STEP 30), a nacelle is raised vertically along the fully formed tower 54.

FIG. 2ze, (STEP 31), the external lifting apparatus is removed thereby completing a wind turbine construction.

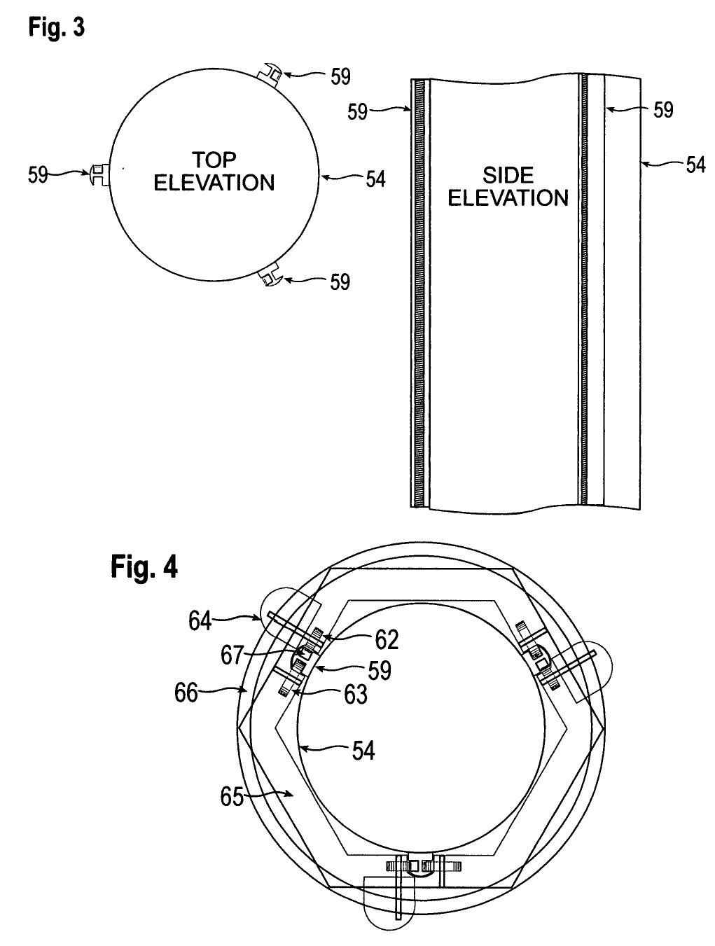

Referring now to FIG. 3, reference numeral 3 denotes top elevation and side elevation views of a tower section 54. The tower section 54 is fabricated of metal and has a cylindrical or polygonal body with a plethora of guide rails 59 mounted vertically along the length of the tower section 54, secured to the guide rails 59 by bolts (not shown) is as illustrated in FIG. 4 a plethora of removable toothed racks 67, tower sections 54 are vertically joined at each end using bolts (not shown) and the like.

Referring now to FIG. 4, reference numeral 4 denotes a top view of a plethora of lifting apparatus contained within a nacelle 50 in situ whilst being vertically penetrated by a tower section 54. Lifting apparatus comprises a cuff 65 formed by a plurality of nacelle sections divisible around the tower penetrating hole, the horizontally static portion of a plethora of heavy duty bearings 66 are mounted on a cuff 65 with the movable portion of these same bearings 66 mounted on a nacelle 50, a multiplicity of toothed cog wheels 62 meshes with the teeth of removable toothed racks 67 secured to guide rails 59 mounted on tower sections 54, a toothed cog wheel 62 is mounted on an axle (not shown) contained within a bearing mechanism (not shown), opposing pressure guide wheels 63 are located on the opposing side of guide rails 59, a opposing pressure guide wheel 63 is mounted on an axle (not shown) contained within a bearing mechanism (not shown), a drive motor 64 is connected to toothed cog wheels 62 directly through an axle configuration (not shown) or through a gearing configuration (not shown).

In another form of this invention, a removable toothed rack 67 are secured to both side grooves of a guide rail 59, a multiplicity of a toothed cog wheel 62 replaces a opposing pressure guide wheel 63, power is mechanically routed to a toothed cog wheel 62 using a gearing configuration or a additional drive motor 64.

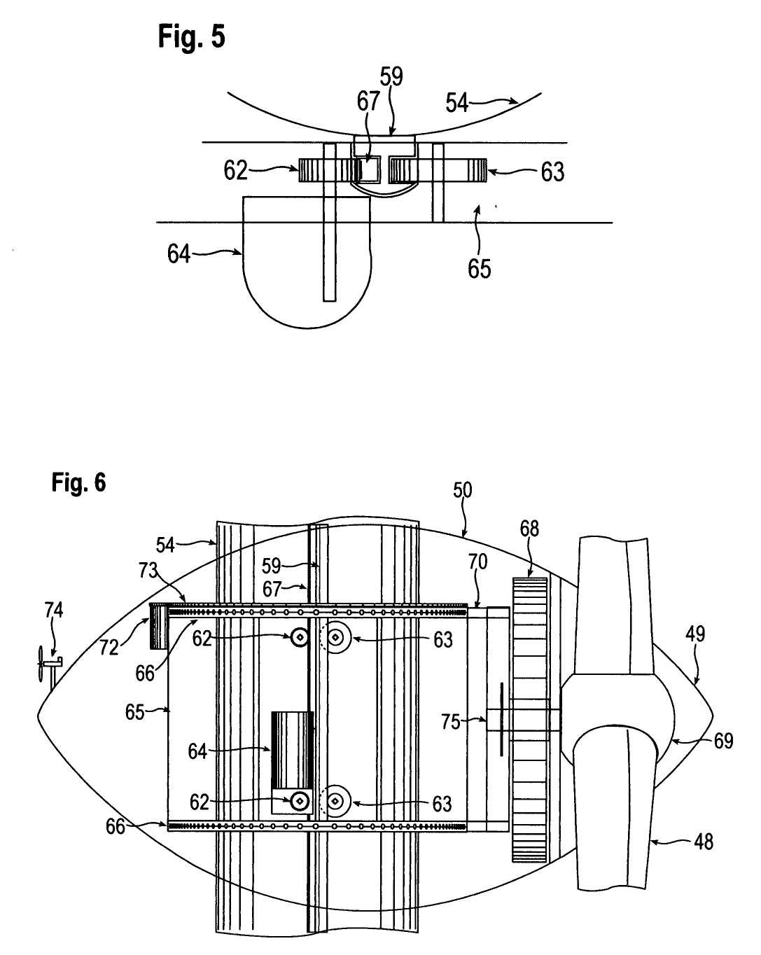

Referring now to FIG. 5, reference numeral 5 denotes a top view of a single lifting apparatus contained within a nacelle 50 in situ whilst being vertically penetrated by a tower section 54. Lifting apparatus comprises a cuff 65 formed by a plurality of nacelle sections divisible around the tower penetrating hole, the horizontally static portion of a plethora of heavy duty bearings 66 are mounted on a cuff 65 with the movable portion of these same bearings 66 mounted on a nacelle 50, a multiplicity of toothed cog wheels 62 meshes with the teeth of removable toothed racks 67 secured to guide rails 59 mounted on tower sections 54, a toothed cog wheel 62 is mounted on an axle (not shown) contained within a bearing mechanism (not shown), opposing pressure guide wheels 63 are located on the opposing side of guide rails 59, a opposing pressure guide wheel 63 is mounted on an axle (not shown) contained within a bearing mechanism (not shown), a drive motor 64 is connected to toothed cog wheels 62 directly through an axle configuration (not shown) or through a gearing configuration (not shown).

In another form of this invention, a removable toothed rack 67 are secured to both side grooves of a guide rail 59, a multiplicity of a toothed cog wheel 62 replaces a opposing pressure guide wheel 63, power is mechanically routed to a toothed cog wheel 62 using a gearing configuration or a additional drive motor 64.

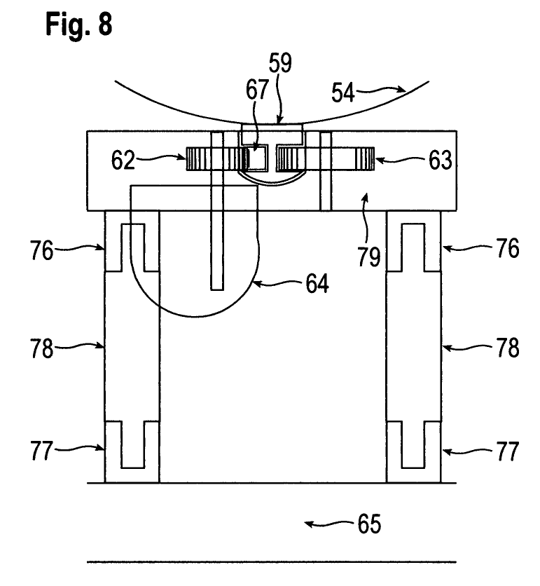

In another form of this invention, a plethora of lifting apparatus previously contained within a nacelle 50 is separated from a nacelle 50 and configured using a separate guide car, a nacelle 50 is joined to a guide car using a adjustable hinge mechanism enabling a guide car and nacelle 50 to travel vertically along a conical shaped tower made of tower sections similar to tower sections 54, this alternate form of this invention is shown in FIG. 8.

Referring now to FIG. 6, reference numeral 6 denotes a vertical cross section view of a nacelle 50, a lifting apparatus and a tower section 54 in situ. Lifting apparatus comprises a cuff 65 formed by a plurality of nacelle sections divisible around the tower penetrating hole, the horizontally static portion of a plethora of heavy duty bearings 66 are mounted on a cuff 65 with the movable portion of these same bearings 66 mounted on a nacelle 50, a multiplicity of toothed cog wheels 62 meshes with the teeth of removable toothed racks 67 secured to guide rails 59 mounted on tower sections 54, a toothed cog wheel 62 is mounted on an axle (not shown) contained within a bearing mechanism (not shown), opposing pressure guide wheels 63 are located on the opposing side of guide rails 59, a opposing pressure guide wheel 63 is mounted on an axle (not shown) contained within a bearing mechanism (not shown), a drive motor 64 is connected to toothed cog wheels 62 directly through an axle configuration (not shown) or through a gearing configuration (not shown), a cuff extension 70 is joined to a cuff 65 by bolts (not shown) and a vibration absorption suspension system (not shown), a electric generator 68 is mounted onto a cuff extension 70 using bolts (not shown), a hub 69 is mounted onto a electric generator 68 using bolts (not shown), a nose cone 49 is mounted onto a hub 69 using bolts (not shown), a multiplicity of a blade 48 is mounted onto a hub 69 using bolts (not shown), a multiplicity of a yaw mechanism 72 is mounted on a nacelle 50, a toothed cog of a yaw mechanism 72 meshes with a multiplicity of a toothed cog 73 mounted on a heavy duty bearing 66, power from a yaw mechanism 72 is transferred into rotational movement of a nacelle 50, directional control of a nacelle 50 is electronically controlled by a anemometer and wind vane 74.

In another form of this invention a hub 69 is mounted onto a nacelle 50 using a bearing (not shown), a cylindrical drive shaft 75 is joined to a hub 69, a cylindrical drive shaft 75 is joined to a electric generator 68, a cylindrical drive shaft 75 is mounted on heavy duty bearings (not shown).

Electrical energy is created by converting the energy of wind into mechanical rotary energy through the medium of a propeller type windwheel possessed of a hub 69 and a plurality of blades 48 and further converting this mechanical rotary energy into electric energy by an electric generator 68.

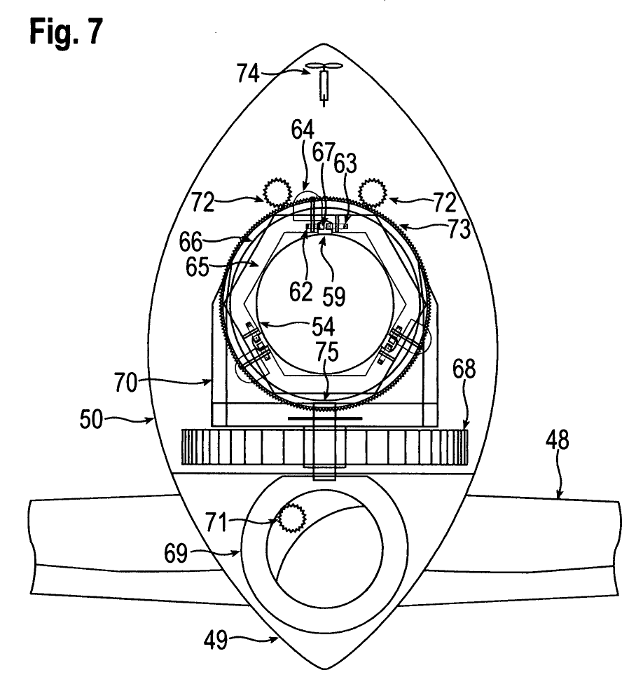

Referring now to FIG. 7, reference numeral 7 denotes a horizontal cross section view of a nacelle 50, a lifting apparatus and a tower section 54 in situ. Lifting apparatus comprises a cuff 65 formed by a plurality of nacelle sections divisible around the tower penetrating hole, the horizontally static portion of a plethora of heavy duty bearings 66 are mounted on a cuff 65 with the movable portion of these same bearings 66 mounted on a nacelle 50, a multiplicity of toothed cog wheels 62 meshes with the teeth of removable toothed racks 67 secured to guide rails 59 mounted on tower sections 54, a toothed cog wheel 62 is mounted on an axle (not shown) contained within a bearing mechanism (not shown), opposing pressure guide wheels 63 are located on the opposing side of guide rails 59, a opposing pressure guide wheel 63 is mounted on an axle (not shown) contained within a bearing mechanism (not shown), a drive motor 64 is connected to toothed cog wheels 62 directly through an axle configuration (not shown) or through a gearing configuration (not shown), a cuff extension 70 is joined to a cuff 65 by bolts (not shown) and a vibration absorption suspension system (not shown), a electric generator 68 is mounted onto a cuff extension 70 using bolts (not shown), a hub 69 is mounted onto a electric generator 68 using bolts (not shown), a nose cone 49 is mounted onto a hub 69 using bolts (not shown), a multiplicity of a blade 48 is mounted onto a hub 69 using bolts (not shown), mounted onto a hub 69 are a multiplicity of a yaw mechanism 71, a toothed cog of a yaw mechanism 71 meshes with a toothed cog mounted on a blade 48, power from a yaw mechanism 71 is transferred into rotational movement of a blade 48, a multiplicity of a yaw mechanism 72 is mounted on a nacelle 50, a toothed cog of a yaw mechanism 72 meshes with a multiplicity of a toothed cog 73 mounted on a heavy duty bearing 66, power from a yaw mechanism 72 is transferred into rotational movement of a nacelle 50, directional control of a nacelle 50 is electronically controlled by a anemometer and wind vane 74.

In another form of this invention a hub 69 is mounted onto a nacelle 50 using a bearing (not shown), a cylindrical drive shaft 75 is joined to a hub 69, a cylindrical drive shaft 75 is joined to a electric generator 68, a cylindrical drive shaft 75 is mounted on heavy duty bearings (not shown).

Electrical energy is created by converting the energy of wind into mechanical rotary energy through the medium of a propeller type windwheel possessed of a hub 69 and a plurality of blades 48 and further converting this mechanical rotary energy into electric energy by an electric generator 68.

Referring now to FIG. 8, reference numeral 8 denotes an alternate form of a lifting apparatus using a horizontal cross section view. In this other form of this invention, a plethora of lifting apparatus shown in FIG. 5 and previously contained within a nacelle 50 is separated from a nacelle 50 and configured using a guide car 79, a nacelle 50 is joined to a guide car 79 using a adjustable hinge mechanism 76, a adjustable hinge mechanism 76 is joined to a hinge separator 78, a hinge separator 78 is joined to a adjustable hinge mechanism 77, a adjustable hinge mechanism 77 is joined to a cuff 65 enabling a guide car 79 and cuff 65 to travel vertically along a conical shaped tower made of tower sections similar to tower sections 54.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. A vertically adjustable horizontal axis type wind turbine having a tower mounted on a base, a nacelle mounted on said tower and a rotor supported by said nacelle, said tower comprising:
a foundation embedded within or connected to said base;
a first stage tower section connected at a lower end thereof with an upper end of said foundation;
a second stage tower section connected at a lower end thereof with an upper end of said first stage tower section;
a third stage tower section connected at a lower end thereof with an upper end of said second stage tower section;
a fourth stage tower section connected at a lower end thereof with an upper end of said third stage tower section;
a fifth stage tower section connected at a lower end thereof with an upper end of said fourth stage tower section;
a sixth stage tower section connected at a lower end thereof with an upper end of said fifth stage tower section.

2. The wind turbine according to claim 1, wherein said nacelle has tower penetrating hole through which said tower vertically penetrates and is formed by a plurality of nacelle sections divisible around said tower penetrating hole.

3. A method of constructing a tower of a vertically adjustable horizontal axis type wind turbine, said tower including a base, a foundation connecting to said base, a first stage tower section connecting to said foundation, a second stage tower section connecting to said first stage tower section, a third stage tower section connecting to said second stage tower section, a fourth stage tower section connecting to said third stage tower section, a fifth stage tower section connecting to said fourth stage tower section, and a sixth stage tower section connecting to said fifth stage tower section, comprising the steps of:
embedding or connecting said foundation on said base in a vertical position;
positioning said nacelle on the top of said construction mechanism providing for said tower section penetration;
positioning said sixth stage tower section inside of said construction mechanism and raising said tower section lowest point to a height not lower than the vertical height of said fifth stage tower section;
locking in place said nacelle holding mechanism;
positioning said fifth stage tower section inside of said construction mechanism and placing it directly beneath said sixth stage tower section;
lowering said sixth stage tower section to abut said fifth stage tower section and connecting said sixth stage tower section to said fifth stage tower section creating a joined tower section;
raising said joined tower section using said construction mechanism so its lowest point is not lower than the vertical height of said fourth stage tower section;
positioning said fourth stage tower section inside of said construction mechanism and placing it directly beneath said joined tower section;
lowering said joined tower section to abut said fourth stage tower section and connecting said joined tower section to said fourth stage tower section creating a joined tower section;
raising said joined tower section using said construction mechanism so its lowest point is not lower than the vertical height of said third stage tower section;
positioning said third stage tower section inside of said construction mechanism and placing it directly beneath said joined tower section;
lowering said joined tower section to abut said third stage tower section and connecting said joined tower section to said third stage tower section creating a joined tower section;
raising said joined tower section using said construction mechanism so its lowest point is not lower than the vertical height of said second stage tower section;
positioning said second stage tower section inside of said construction mechanism and placing it directly beneath said joined tower section;
lowering said joined tower section to abut said second stage tower section and connecting said joined tower section to said second stage tower section creating a joined tower section;
raising said joined tower section using said construction mechanism so its lowest point is not lower than the vertical height of said first stage tower section;
positioning said first stage tower section inside of said construction mechanism and placing it directly beneath said joined tower section;
lowering said joined tower section to abut said first stage tower section and connecting said joined tower section to said first stage tower section creating a joined tower section;
removing said guide rail and guide car from said construction mechanism;
lowering said joined tower section to abut said foundation and connecting said joined tower section to said foundation creating a completed tower;
unlocking said nacelle holding mechanism and lowering said nacelle and said nacelle holding mechanism.

4. A construction mechanism of a vertically adjustable horizontal axis type wind turbine, said construction mechanism including;
a foundation structure;
a tower section hoist mechanism;
said tower section hoist mechanism including:
a tower section clamping mechanism;
a tower section guide mechanism;
a nacelle holding mechanism;
a plethora of stabilizing support mechanisms;
a guide rail and guide car mechanism.

5. A method of mounting a nacelle of a vertically adjustable horizontal axis type wind turbine on a tower thereof, said nacelle including a penetrating hole through which said tower vertically penetrates and is formed by a plurality of nacelle sections divisible around said tower penetrating hole, comprising the steps of:
connecting a plurality of said nacelle sections and forming said nacelle prior to being lifted and penetrated by said tower;
lifting said nacelle onto said mounting mechanism prior to being penetrated by said tower;
lifting said tower sections to penetrate said tower;
connecting and mounting said motorized nacelle lifting mechanism with said tower rails and said cogs;
connecting and mounting said tower mounted electronic and electrical equipment with said nacelle.

6. A vertically adjustable horizontal axis type wind turbine, comprising:
a base;
a foundation embedded within or connected to said base;
a tower mounted on said foundation;
a nacelle mounted on said tower and having a penetrating hole being penetrated by said tower so as to enable vertical movement up and down of said nacelle along said tower;
a rotor supported by said nacelle;
a guide rail mechanism being biased on an outer surface of said tower so as to enable vertical movement up and down said tower by said nacelle;
said guide rail mechanism including:
a plurality of guide rails;
a plurality of toothed racks connected to said guide rails;
a lifting mechanism provided in said nacelle to enable vertical movement up and down said tower by said nacelle;
said lifting mechanism including:
a plurality of cogs so as to enable meshing with said plurality of toothed racks;
a plurality of opposing pressure guide wheels;
a plurality of drive motors;
a plurality of bearings;
a plurality of axles;
a plurality of gearing drive trains.

7. A vertically adjustable horizontal axis type wind turbine, comprising:
a base;
a foundation embedded within or connected to said base;
a tower mounted on said foundation;
a nacelle mounted on said tower and having a penetrating hole being penetrated by said tower so as to enable vertical movement up and down of said nacelle along said tower; and
a rotor supported by said nacelle;
said nacelle being formed by a plurality of nacelle sections divisible around said penetrating hole, said sections being connected with each other around said tower when mounting said nacelle on said tower.

8. A vertically adjustable horizontal axis type wind turbine, comprising:
a base;
a foundation embedded within or connected to said base;
a tower mounted on said foundation;
a nacelle mounted on said tower and having a penetrating hole being penetrated by said tower so as to enable vertical movement up and down of said nacelle along said tower; and
a rotor mounted on a drive shaft mechanism support rotatably supported by said nacelle.

9. A vertically adjustable horizontal axis type wind turbine according to claim 5, wherein a guide car mechanism is added to said lifting mechanism to enable said nacelle and said guide car mechanism to travel vertically up and down a conical shaped said tower;
said guide car mechanism, including:
a plurality of guide cars;
a plurality of adjustable hinge mechanisms;
a plurality of hinge separators.

10. A vertically adjustable horizontal axis type wind turbine, comprising:
a tower mounted on a foundation provided by an external party;
a nacelle mounted on said tower and having a penetrating hole being penetrated by said tower so as to enable vertical movement up and down of said nacelle along said tower; and
a rotor mounted on said nacelle.

11. A vertically adjustable horizontal axis type wind turbine, comprising:
a tower mounted on a foundation provided by an external party;
a nacelle mounted on said tower and having a penetrating hole being penetrated by said tower so as to enable vertical movement up and down of said nacelle along said tower; and
a rotor mounted on a drive shaft mechanism support rotatably supported by said nacelle.
